(19) United States
(12) Patent Application Publication
(10) Pub. No.: US 2004/0213004 A1
(43) Pub. Date: Oct. 28, 2004

(54) Apparatus and method for mounting lights on a pole

(76) Inventors: Bruce A. Swee, Seattle, WA (US); Christine C. Schaefer Swee, Seattle, WA (US)

Correspondence Address: Frank J. Bozzo, Esq., BLACK LOWE & GRAHAM PLLC, 816 Second Avenue, Seattle, WA, 98104, US

(21) Appl. No.: 10/422,478

(22) Filed: Apr. 23, 2003

(51) Int. Cl. F21S 8/00

(52) U.S. Cl. 362/432

(57) ABSTRACT

An apparatus and a method are provided for mounting lights on a supporting pole. A mounting sleeve configured to receive a supporting pole is provided. The mounting sleeve has inner cross-sectional dimensions sufficiently large so as to be slidable along a major axis of the supporting pole and small enough to engage the supporting pole such that the mounting sleeve is generally constrained from tilting in orthogonal dimensions to the major axis of the supporting pole. A plurality of support arms are coupled to the mounting sleeve and extend outwardly from an outer surface of the mounting sleeve. A plurality of light supports are coupled with the plurality of support arms.

### FIELD OF THE INVENTION

This invention relates generally to lighting and, more specifically, to supporting self-contained lights.

### BACKGROUND OF THE INVENTION

Candles, oil lights, and other forms of ambience lighting continue to be an increasingly popular aspect of decor. Certainly, a “candle-light dinner” continues to be the symbol of a romantic dinner. Candles also continue to be very popular choices for outside evening lighting. Flames offer softer light than electric lights, and tend not to attract as many insects. In fact, as is commonly known, candles are specially formulated for outdoor use to actually repel mosquitoes and other insects.

Although candles and other flame-type lights are so popular, they do present a concern: sometimes it is difficult to find a suitable place to position candles and other such lights. Candles take up table space. The candles themselves may have an appreciable cross-section, and commonly a candleholder of some sort is desired to catch dripping wax to protect surfaces beneath. Moreover, because candles present a flame, there must be sufficient room left around a candle to prevent people near the candle from accidentally burning themselves. Also, it is undesirable for hands or other body parts to come too close to what may be an unwelcome heat source. Further, there is always a desire to keep open flames out of the reach of children.

These concerns are magnified in a dining situation where the dining table already may be filled with plates, bowls, glasses, and other items present on a dinner table. Space is in even shorter supply on many outdoor dining tables where a floor-standing umbrella may extend through a center of the dining table, effectively consuming the very center of the table.

In addition to the concern of simply making space for candles, there is also the concern of the consequences of one or more candles being knocked over. Certainly, a tipped candle presents a risk of starting a fire. A tipped candle also might burn someone who unfortunately comes in contact with the flame or is splashed with hot wax. The spilled wax also can ruin clothing or surfaces onto which the wax spills. These concerns also are magnified in a dining situation where diners reach for food, pass plates, lift glasses, and undertake all the constant hand and arm movements that attend everyday dining.

As a result of these concerns, there are unmet needs in the art for an apparatus for allowing the use of candles and other flame-type lights without consuming potentially limited table space, as well as in allowing the use of candles and other flame-type lights while protecting people and objects from the risk of candles being tipped.

### SUMMARY OF THE INVENTION

Embodiments of the present invention provide an apparatus and a method for mounting lights on a pole. The apparatus and method provide for a mounting sleeve to be positioned on a supporting pole, such as a central supporting pole of a table umbrella. Support arms extend outwardly from the mounting sleeve and support a plurality of light supports. Advantageously, the apparatus and method allow the lights to be positioned above the table surface to free table space. Further advantageously, the mounting sleeve prevents supporting arms and, therefore, the light supports and lights supported from tipping, thereby preventing accidental tipping of the lights.

More particularly, embodiments of the present invention include a mounting sleeve configured to receive a supporting pole therein. The mounting sleeve has inner cross-sectional dimensions sized so that the mounting sleeve is slidable along a major axis of the supporting pole and such that the mounting sleeve is generally constrained from tilting in orthogonal dimensions to the major axis of the supporting pole. A plurality of support arms are coupled to the mounting sleeve and extend outwardly from an outer surface of the mounting sleeve. A plurality of light supports are coupled to the plurality of support arms.

In accordance with further aspects of the present invention, a positioning device configured to secure the mounting sleeve to the supporting pole is included such that deploying the positioning device limits the slidability of the mounting sleeve along the major axis of the supporting pole in at least one direction. The positioning device suitably is in the nature of a clamp for frictionably engaging the supporting pole, at least one spacing sleeve for positioning the mounting sleeve along the major axis of the supporting pole at a distance removed from a surface, or a cap to engage a top end of the supporting pole. In addition, the support arms can be shaped in at least one of a straight shape, an upward-reaching shape, a downward-reaching shape, an upswept shape, a downswept shape, or a curved shape. Different support arms of the same apparatus can have different shapes and different lengths. Also, multiple support arms can support a single light support, or a single support arm can support multiple light supports. A shaped member also can be supported by at least one of the support arms or the light supports. Further, a light support can be configured to support a light holder from beneath, or the light support can include a receiving opening and supporting arms such that a light holder can be inserted into the receiving opening and retained in position by the supporting arms.

### BRIEF DESCRIPTION OF THE DRAWINGS

The preferred and alternative embodiments of the present invention are described in detail below with reference to the following drawings.

FIG. 1 is a perspective view of one exemplary embodiment of the present invention supporting a plurality of light holders;

FIG. 2A is a side view of the apparatus shown in FIG. 1;

FIG. 2B is a top view of the apparatus shown in FIG. 1;

FIG. 3A is a top view of a variation of one exemplary embodiment of the present invention;

FIG. 3B is a top view of another variation of one exemplary embodiment of the present invention;

FIG. 3C is a top view of another variation of one exemplary embodiment of the present invention;

FIG. 3D is a top view of a another variation of one exemplary embodiment of the present invention;

FIG. 4A is a partial side view of one variation of a mounting sleeve, a support arm, and a light support according to an embodiment of the present invention;

FIG. 4B is a partial side view of another variation of a mounting sleeve, a support arm, and a light support according to an embodiment of the present invention;

FIG. 4C is a partial side view of another variation of a mounting sleeve, a support arm, and a light support according to an embodiment of the present invention;

FIG. 5A is a partial side view of a mounting sleeve, a support arm, and a variation of a light support according to an embodiment of the present invention supporting a light holder;

FIG. 5B is a partial top view of the apparatus shown in FIG. 5A;

FIG. 6A is a side view of one exemplary embodiment of the present invention supported by a positioning device according to one embodiment of the present invention;

FIG. 6B is a top view of the positioning device used in FIG. 6A;

FIG. 6C is a side view of one exemplary embodiment of the present invention supported by another positioning device according to one embodiment of the present invention;

FIG. 6D is a top view of the positioning device used in FIG. 6C;

FIG. 7A is a side view of one exemplary embodiment of the present invention supported by a positioning device according to another embodiment of the present invention;

FIG. 7B is a side view of one exemplary embodiment of the present invention supported by a plurality of positioning devices according to another embodiment of the present invention;

FIG. 8 is a flowchart of a routine of an embodiment of the present invention.

### DETAILED DESCRIPTION OF THE INVENTION

By way of overview, embodiments of the present invention include an apparatus for mounting lights on a pole. The apparatus includes a mounting sleeve configured to receive a supporting pole. The mounting sleeve has inner cross-sectional dimensions sized such that the mounting sleeve is slidable along a major axis of the supporting pole and such that the mounting sleeve is generally constrained from tilting in orthogonal dimensions to the major axis of the supporting pole. A plurality of support arms are coupled to the mounting sleeve and extend outwardly from an outer surface of the mounting sleeve. A plurality of light supports are coupled to the plurality of support arms.

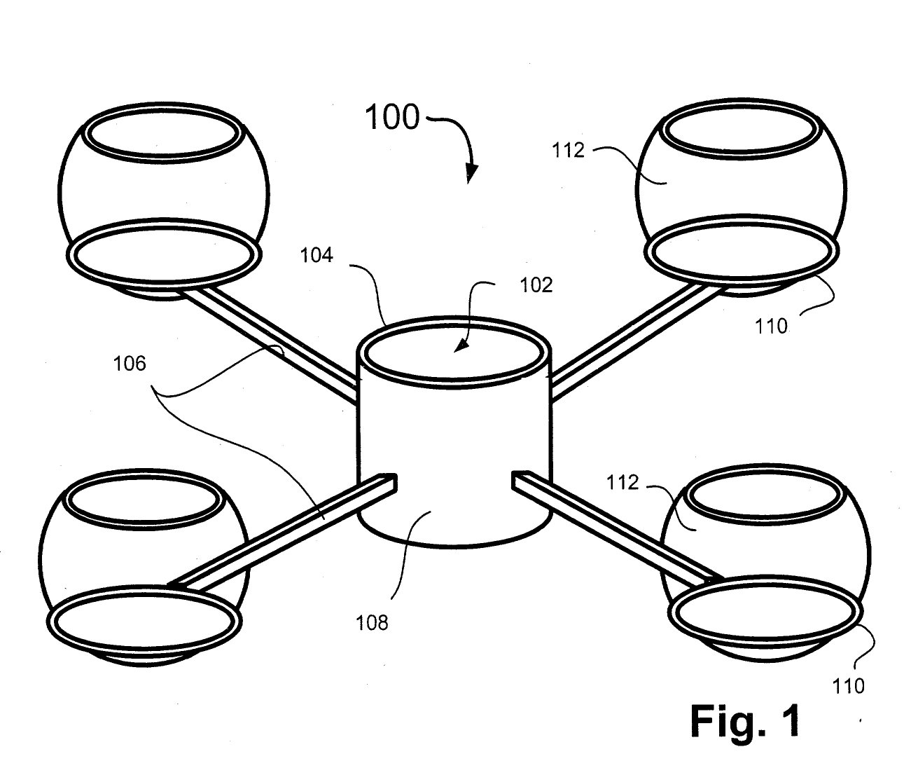

By way of further overview, FIG. 1 shows a perspective view of a lighting support apparatus 100 according to one exemplary embodiment of the present invention. The lighting support apparatus 100 shown in FIG. 1 is configured to be mounted on a generally cylindrical pole (not shown) by inserting the pole through an interior opening 102 of a mounting sleeve 104. In one context, the pole (not shown) might be a central supporting pole of a floor-standing table umbrella. In such a context, the lighting support apparatus can be slid onto the central supporting pole of the umbrella, and then the supporting pole of the umbrella can be inserted into an opening in a dining table where it might be received into a mounting base. Thus, the lighting support apparatus 100 would be secured to the central supporting pole and supported above a surface of the table. A plurality of support arms 106 extend outwardly from an outer surface 108 of the mounting sleeve 104. At ends of the support arms 106 opposite the mounting sleeve 104, light supports 110 are disposed. The light supports 110 as shown in FIG. 1 support generally spherical candle holders 112. As a result, the light support apparatus 100 provides the table (not shown) with a central location to position candle holders 112 containing candles (not shown), or other lights. Details and variations of the light support apparatus 100 and its uses are further described in the text below and in the attached figures.

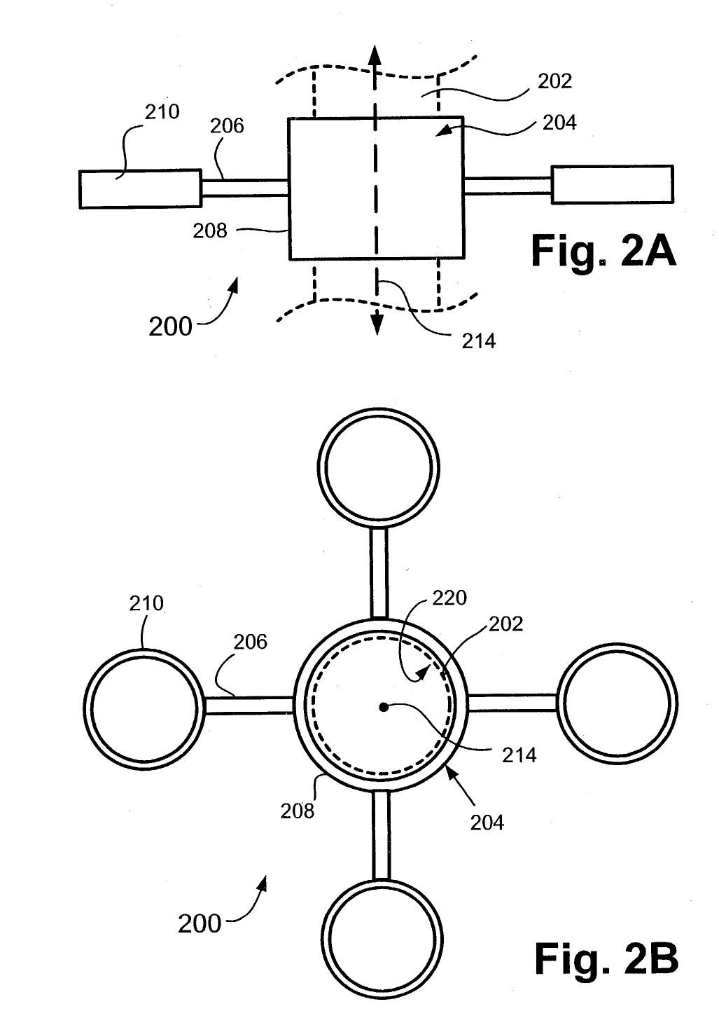

FIGS. 2A and 2B show in more detail how one presently preferred embodiment of the present invention is installed on the central supporting pole of an umbrella or another supporting pole. FIG. 2A is a side view showing how the apparatus 200 is slidably mounted on a supporting pole 202. The supporting pole 202 extends through an inner opening (not shown) in the mounting sleeve 204. The apparatus 200 then can be slid over the supporting pole 202 along a major axis 214 of the supporting pole 202. Support arms 206 extend outwardly from an outer surface 208 of the mounting sleeve 204. Light supports 210 are coupled at opposite ends of the support arms 206. Thus, FIG. 2A shows how the apparatus 200 is configured to fit a supporting pole 202 and outwardly support a plurality of lights.

FIG. 2B is a top view showing in more detail how the apparatus 200 engages the supporting pole 202. An interior opening 220 of the mounting sleeve 204 preferably is sized to closely fit the supporting pole 202. As will be appreciated, a close fitting of the interior opening 220 of the mounting sleeve 204 to the supporting pole 202 restricts the movement of the apparatus 200 in the plane orthogonal to the major axis 214 of the supporting pole 202. In the exemplary embodiment of the lighting support apparatus 200 shown in FIG. 2B, the mounting sleeve 204 is shown to be annular in shape with a cylindrical interior opening 220 shaped to receive the generally cylindrical supporting pole 202. However, it will be appreciated that a supporting pole 202 could be elliptical, triangular, square, or have any other cross-sectional shape, and the interior opening 220 and/or the mounting sleeve 204 could be shaped to accommodate the supporting pole 202 and engage sides of the supporting pole 202 to prevent the mounting sleeve 204 from tilting relative to the major axis 214 of the supporting pole 202. As also can be seen in FIG. 2B, the support arms 206 extend outwardly from the exterior surface 208 of the mounting sleeve 204 to the light supports 210 to support lights around the supporting pole 202.

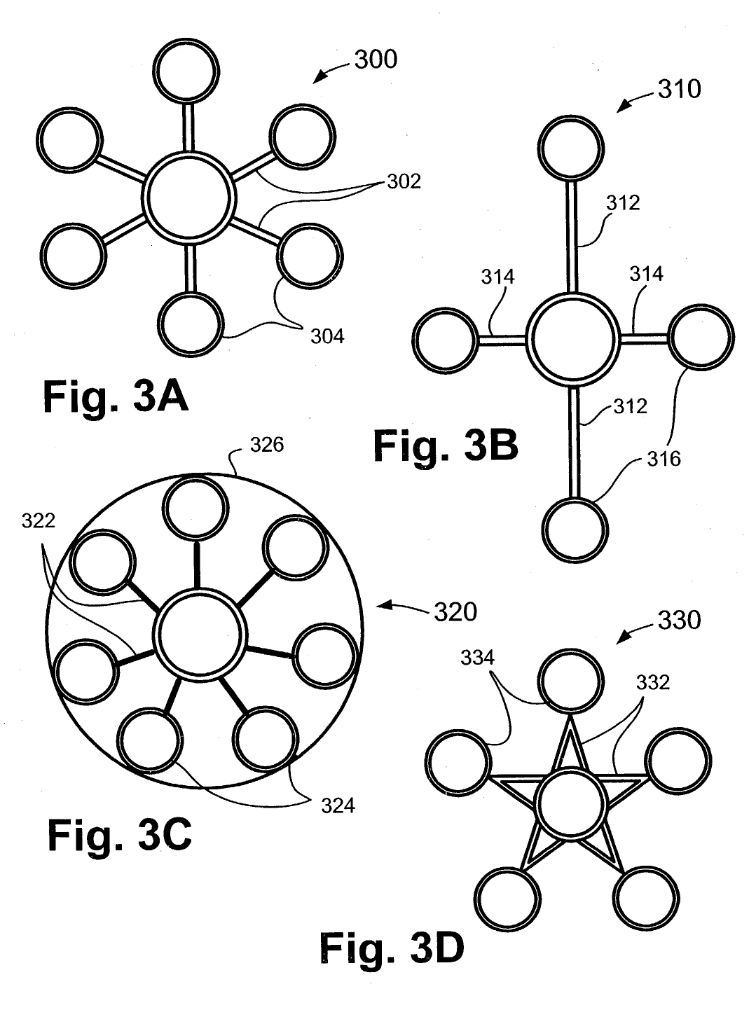

FIGS. 3A-3D are four additional, top-view illustrations showing that embodiments of the present invention can be formed to support any desired number lighting devices, take on a number of shapes to fit different tables, or take on ornamental shapes. Embodiments of the invention shown in FIGS. 1, 2A, and 2B depict a general, daisy-shaped apparatus supporting four lights.

FIG. 3A shows an embodiment of an apparatus 300 of the present invention which also is daisy-shaped. However, in this exemplary embodiment, features six support arms 302 supporting six light supports 304 to support up to six lights (not shown).

FIG. 3B again shows an apparatus 310 having a daisy-shaped configuration. However, the apparatus 310, instead of having support arms of equal length, has two long support arms 312 and two short support arms 314 supporting a total of four light supports 316. Such an apparatus 310 suitably is used with an oval-shaped table top (not shown) with the two long support arms 312 arrayed toward the wider ends of the table top, or suitably is used for effecting an asymmetrical appearance above a round table top (not shown).

FIG. 3C shows an apparatus 320 exhibiting other variations of the present invention. The apparatus 320 here again has daisy-shaped support arms 322 of equal lengths. The apparatus 320, however, is distinct from other exemplary embodiments previously shown in at least three ways. First, the apparatus 320 features an odd number of support arms 322 supporting an odd number of light supports 324. Thus, it will be appreciated that embodiments of the present invention are not limited to even numbered or mirror-symmetrical shapes. Second, as shown by contrast between the apparatus 300 (FIG. 3A) and the apparatus 320 (FIG. 3C), thickness of the support arms 302 and 322, respectively, can vary depending on the weight of the lights to be supported, aesthetic choice, and other aspects. Third, and perhaps most readily apparent from FIG. 3C, the apparatus 320 features an outer member 326 joined to the light supports 304. The outer member 326 can lend structural rigidity and/or a different aesthetic appearance to the apparatus 320.

The apparatus 320 of FIG. 3C shows an outer member 326 in the form of an outer concentric ring. A number of aspects of the outer member and possible variations will be appreciated. For one non-limiting example, it will also be appreciated that such an outer member 326, whether a concentric ring or any other shape, could be joined to one or more of the support arms 322 and/or one or more of the light supports. For another non-limiting example, the outer member 326 can take on a number of shapes; the outer member suitably could be a number of concentric circles, a square, a favored outline such as a peace symbol or an outline of the State of Texas, or any number of shapes.

FIG. 3D shows an apparatus 330 having multiple support arms 332 supporting single light supports 334. In this particular example, there are two support arms 332 for each light support 334, with each pair of the support arms 332 meeting at a point at the light supports 334 to form a five-pointed star. It will be appreciated that the support arms 332 and light supports 334 could be arranged to achieve six-pointed stars, or other shapes that offer a combination of structural rigidity and desired appearance by using of multiple support arms 332.

Although not shown in these figures, it will be appreciated that other variations are possible in the design and production of embodiments of the present invention. First, embodiments of the present invention could be collapsible, with the mounting sleeve, support arms and/or light supports being detachable for shipping and/or storage. Such a detachable design also allows for the possibility of modularity in allowing a user to install as many support arms and/or light supports as the user may desire for a particular event or occasion. In addition, a variety of materials could be used in embodiments of the present invention. Embodiments of the invention could be made of metal, plastic, wood, glass, or other materials, and a mixture of materials can be used in a single device. Sections of embodiments of the invention can be joined using techniques known to one of ordinary skill in the art. Also, while embodiments of the invention shown in the figures all have enclosed mounting sleeves, the mounting sleeves can be partially open in circumference and still suitably engage a supporting pole as previously described.

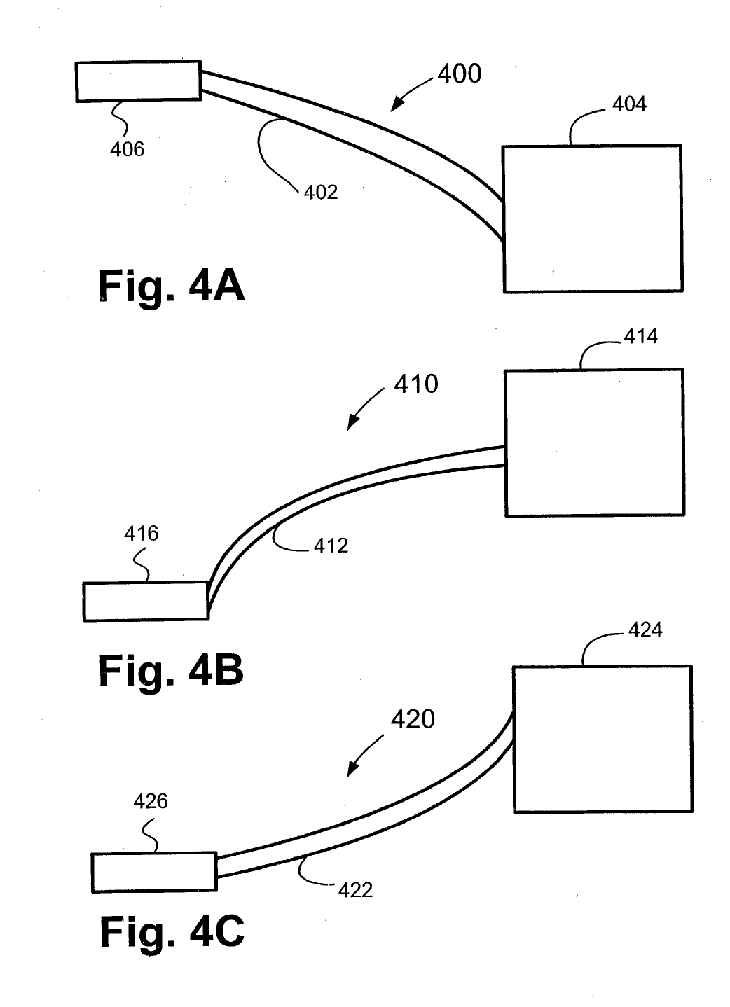

While FIGS. 3A-3D present top views showing alternative forms of embodiments of the present invention, FIGS. 4A-4C show side views of alternative forms of the invention. As the side views of FIGS. 4A-4C show, support members 402, 412, and 422 can assume a number of different shapes depending on aesthetic and practical considerations. FIG. 4A shows a partial side view of an apparatus 400 according to one embodiment of the present invention. The apparatus 400 includes an upward-extending, slightly downward curving support arm 402 connecting the mounting sleeve 404 and the light support 406. A support arm 402 with such a shape would allow a light (not shown) resting on the light support 406 to be lifted up above the mounting sleeve 404. FIG. 4B shows a partial side view of an apparatus 410 according to another embodiment of the invention using a downward-reaching, slightly downward curving support arm 412 coupling the mounting sleeve 414 with the light support 416. A support arm 412 with such a shape would allow a light (not shown) resting on the light support to be positioned below the mounting sleeve 414. Thus, if for some reason the mounting sleeve 414 could not be positioned as low as desired, the downward-reaching support arm 412 effectively lowers the position of the light. FIG. 4C shows a partial side view of an apparatus 420 according to another embodiment of the invention using a downward-reaching, slightly upward curving support arm 422 coupling the mounting sleeve 424 with the light support 426. Like the apparatus 410 shown in FIG. 4B, the support arm 422 allows a light (not shown) to be positioned below the height of the mounting sleeve 424.

Comparing FIGS. 4B and 4C, it will be appreciated that both apparatuses 410 and 420 allow a light (not shown) to be positioned below the height of the mounting sleeve. Thus, a difference between choosing the downward curving support arm 412 and the upward curving support arm 422 is made on the basis of aesthetics. Accordingly, shapes of the support arms can be made based on practical and/or aesthetic considerations using embodiments of the present invention.

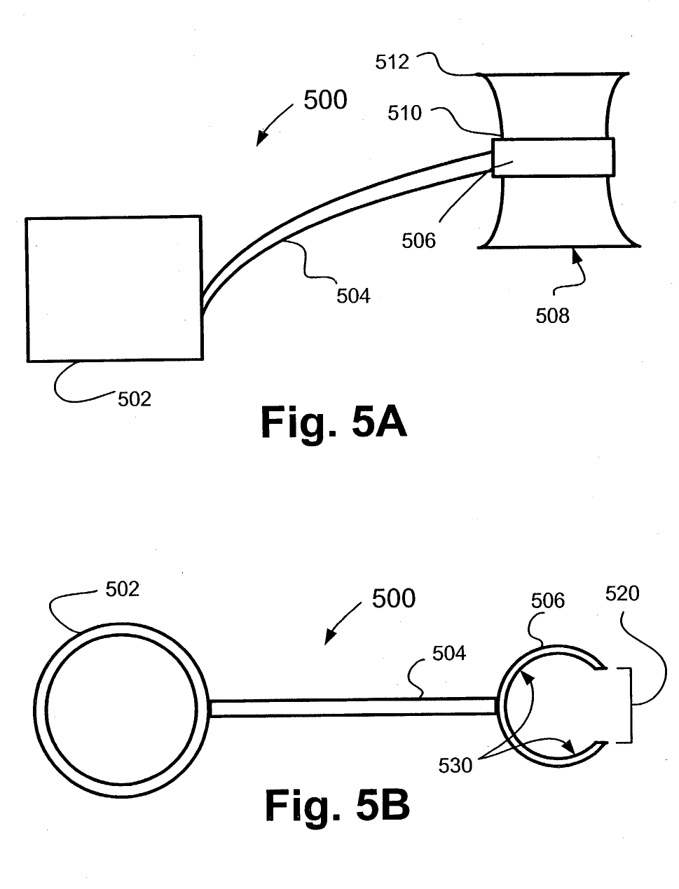

FIGS. 5A and 5B show another variation of the present invention. As FIGS. 3A-3D and FIGS. 4A-4C present alternative configurations and shapes of support arms, FIGS. 5A and 5B show an alternative configuration of a light support 506. The apparatus 500 partially shown in FIG. 5A features a mounting sleeve 502 joined by a support arm 504 to the light support 506. However, unlike the apparatus 100 (FIG. 1) which has a light holder 112 resting on its light support 110, the light support 506 of the apparatus 500 supports a light holder 508 that rests within the light support 506. As shown in FIG. 5A, the light holder 508 narrows toward its midsection 510 as compared to its top end 512. Thus, as shown in FIG. 5B, a cutaway 520 in the light support 506 suitably is configured to receive the narrowed width of the light holder 508 at its midsection 510. Then, when the light holder 508 is lowered into place in the light support, side pieces 530 of the light support engage sides of the light holder 508, supporting the light holder in place 508.

It will be appreciated that the light supports can take on many different forms. In addition to the light supports of FIGS. 1-5, the light supports could be solid or largely solid planar or bowl-shaped structures. The light supports also could include a plurality of finger-shaped elements formed to hold a candle holder as a person might hold the same candle holder in the fingers of his or her upturned hand. In addition, the light supports could be in the form of a single upwardly directed spike which could be inserted into a bottom surface of a wax candle to hold the candle in place. Embodiments of the present invention can include light supports of any number or shapes.

Thus, in summary, embodiments of the present invention provide for many possible ways to shape mounting sleeves, support arms, and light supports to suit a variety of practical and aesthetic considerations, as well as to receive light holders of many different shapes.

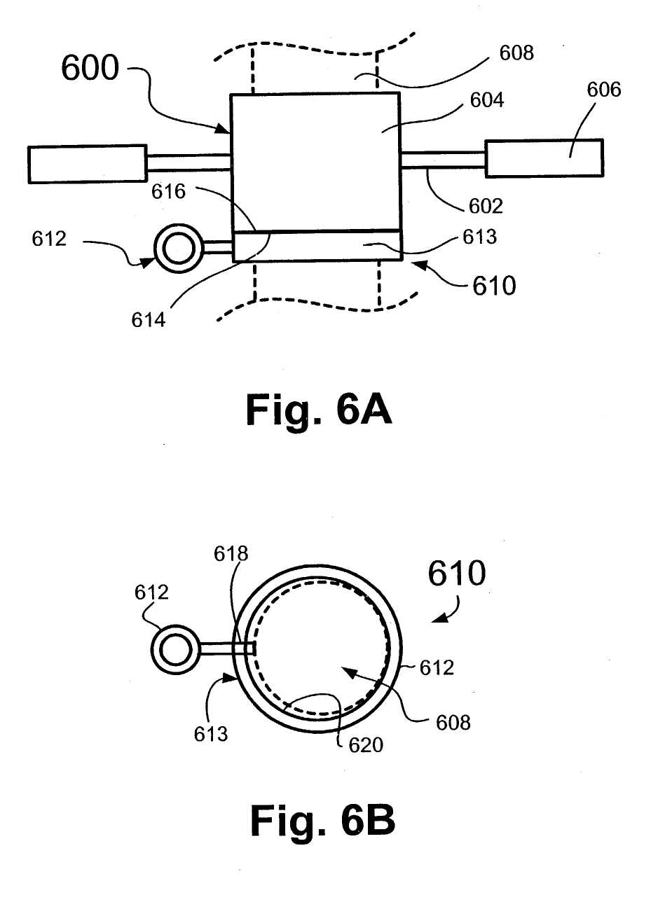

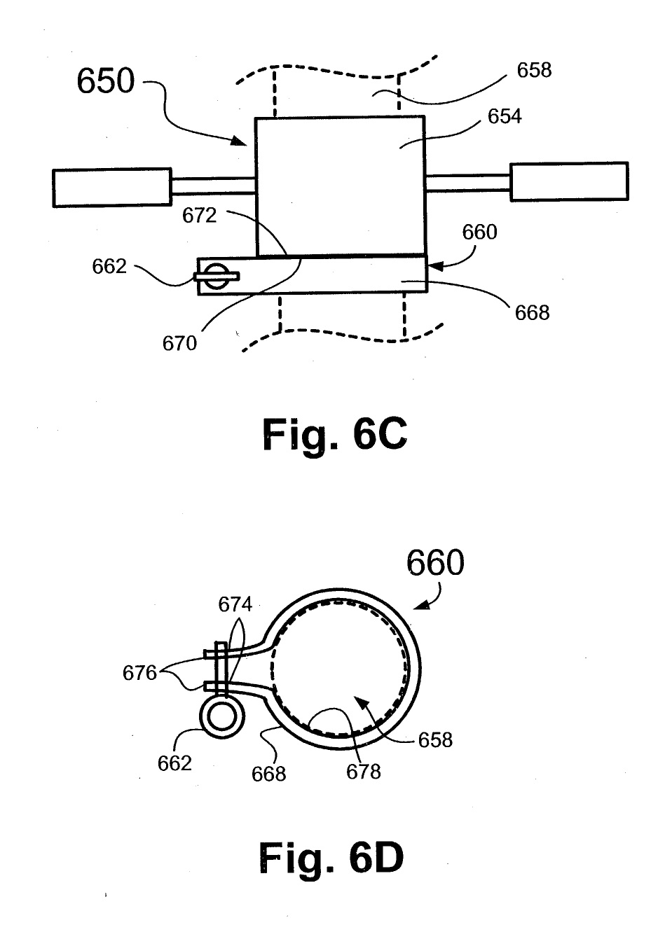

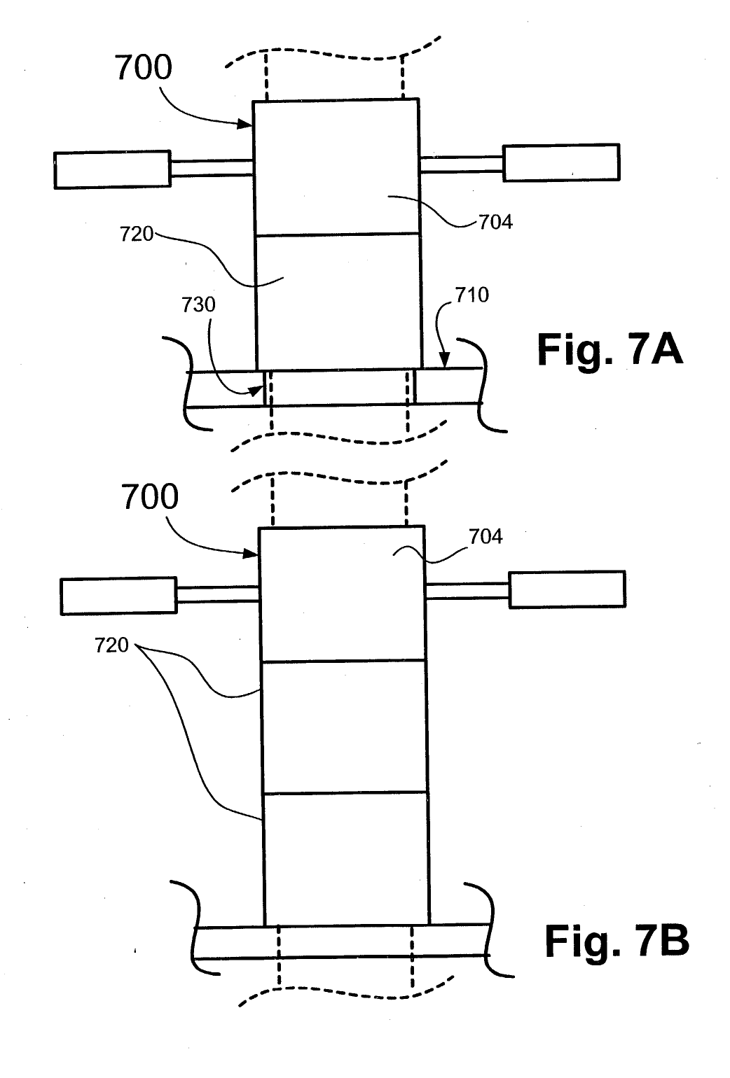

Considering the mounting of embodiments of the present invention, in the example of the apparatus being mounted on a central supporting pole of a table umbrella mounted on a dining table, positioning of the apparatus is suitably straightforward. In such a case, a lower edge of the apparatus can rest on the table top, and the apparatus is held in place from tipping by the mounting sleeve engaging the central supporting pole. However, in cases where users wish to position the apparatus above the surface of the table top or otherwise mount the apparatus on a pole where the apparatus will be not be supported from below, other support for the apparatus is desired. FIGS. 6A-6D and FIGS. 7A and 7B show alternative mechanisms for positioning embodiments of the present invention on a supporting pole.

FIGS. 6A-6D show how apparatuses of the present invention can be positioned using clamping devices 610 and 660. FIG. 6A once again shows an apparatus 600 with support arms 602 extending from a mounting sleeve 604 and supporting the light supports 606. The apparatus 600 is mounted on a supporting pole 608 and, as can be seen in FIG. 6A, is not resting on a table top or other surface. Instead, the apparatus is held in place by a clamping device 610. The clamping device 610 is frictionably secured to the supporting pole 608 by an adjustment screw 612 which is threaded through a clamp sleeve 613. Once the clamping device 610 is secured in place, an upper edge 614 of the clamping device 610 engages a lower edge 616 of the mounting sleeve 604, holding the apparatus 600 in place. As long as outer dimensions of the clamping device 610 are larger than inner dimensions of the mounting sleeve 604, the apparatus 600 is restrained from sliding along a major axis (not shown) of the pole in one direction. Accordingly, if the clamping device 610 is installed on the supporting pole 608 below where the apparatus 600 will rest, the clamping device 610 supports the apparatus 600 from below while gravity keeps the apparatus 600 in place.

FIG. 6B shows a top view of the clamping device 610. The clamp sleeve 613 fits around the supporting pole 608 similar to the manner in which the mounting sleeve 604 (FIG. 6A) of the apparatus 600 fits around the supporting pole 608. In the case of the clamping device 610, however, the adjustment screw 612 is turned through a threaded opening 618 of the clamp sleeve 613, causing the adjustment screw 612 and an inner surface 620 of the clamp device 610 to frictionably engage the supporting pole 608. As will be appreciated, the clamping device 610 is secured to the supporting pole 608 and can support the weight of the apparatus 600, light holders (not shown), and lights (not shown) in place on the supporting pole.

FIGS. 6C and 6D show a similar arrangement for supporting an apparatus 650 in place on a supporting pole 658 using another form of clamping device 660. The apparatus 650 is mounted on a supporting pole 658 and, as can be seen in FIG. 6C, is not resting on a table top or other surface. Instead, the apparatus is held in place by a clamping device 660. The clamping device 660 is frictionably secured to the supporting pole 658 by an adjustment screw 662 which is threaded through threaded holes 674 in ends 676 of the clamp 668. Once the clamping device 660 is secured in place, an upper edge 670 of the clamping device 660 engages a lower edge 672 of the mounting sleeve 654, holding it in place. As long as outer dimensions of the clamping device 660 are larger than inner dimensions of the mounting sleeve 654, the apparatus 650 is restrained from sliding along a major axis (not shown) of the pole in one direction. Accordingly, if the clamping device 660 is installed on the supporting pole 658 below where the apparatus 650 will rest, the clamping device 660 supports the apparatus 650 from below while gravity keeps the apparatus 650 in place.

FIG. 6D shows a top view of the clamping device 660. The clamp 668 fits around the supporting pole 608. In the case of the clamping device 660, however, the adjustment screw 662 is turned through threaded openings 674 in ends 676 of the clamp 660, causing inner surfaces 678 of the clamp 660 to frictionably engage the supporting pole 658. As will be appreciated, the clamping device 660 is secured to the supporting pole 658 and can support the weight of the apparatus 650, light holders (not shown), and lights (not shown) in place on the supporting pole.

FIGS. 7A and 7B show alternative means for positioning an apparatus 700 above a surface 710. Just as the clamping devices 610 (FIGS. 6A and 6B) and 660 (FIGS. 6C and 6D) each support apparatus 600 (FIG. 6A) or 650 (FIG. 6C) from below, FIGS. 7A and 7B using spacing sleeves 720 to achieve a similar result. Like the clamping devices 610 and 660, the spacing sleeves 720 rely on the outer dimensions of the spacing sleeves being at least as large as the inner dimensions of the mounting sleeve 704 to engage and support the apparatus 700. Also, as will be appreciated, outer dimensions of the spacing sleeves have to be larger than inner dimensions of a pole-receiving opening 730 in the surface 710 such that the spacing sleeves 720 do not fall within the pole-receiving opening 730. The spacing sleeves 720 support the apparatus over the surface 710 by a length of the spacing sleeve 720. Also, as shown in FIG. 7B, multiple spacing sleeves can be stacked to increase the height the apparatus 700 is positioned over the surface 710.

While not shown in the figures, embodiments of the present invention also could be positioned on an end of a pole by using a cap at an upper end of the mounting sleeve. A cap on the upper end of the mounting sleeve similarly would limit the slidabilty of the apparatus and thereby position an apparatus in place.

It will be appreciated that positioning devices such as the clamping devices 610 (FIGS. 6A and 6B) and 660 (FIGS. 6C and 6D) and/or the spacing sleeves 720 (FIG. 7) can physically be integrated into the mounting sleeves of various forms of the apparatus in various ways. For one non-limiting example, a spacing sleeve 720 could be integrated with the mounting sleeve to provide a nominal level of spacing above a surface. To such an implementation, one or more additional spacing sleeves 720 or a clamping device 610 or 660 could be used to further space the apparatus above the surface. For another non-limiting example, a clamping device 610 or 660 could be integrated into the mounting sleeve with the adjustment screw threaded through the mounting sleeve for positioning the apparatus above the surface.

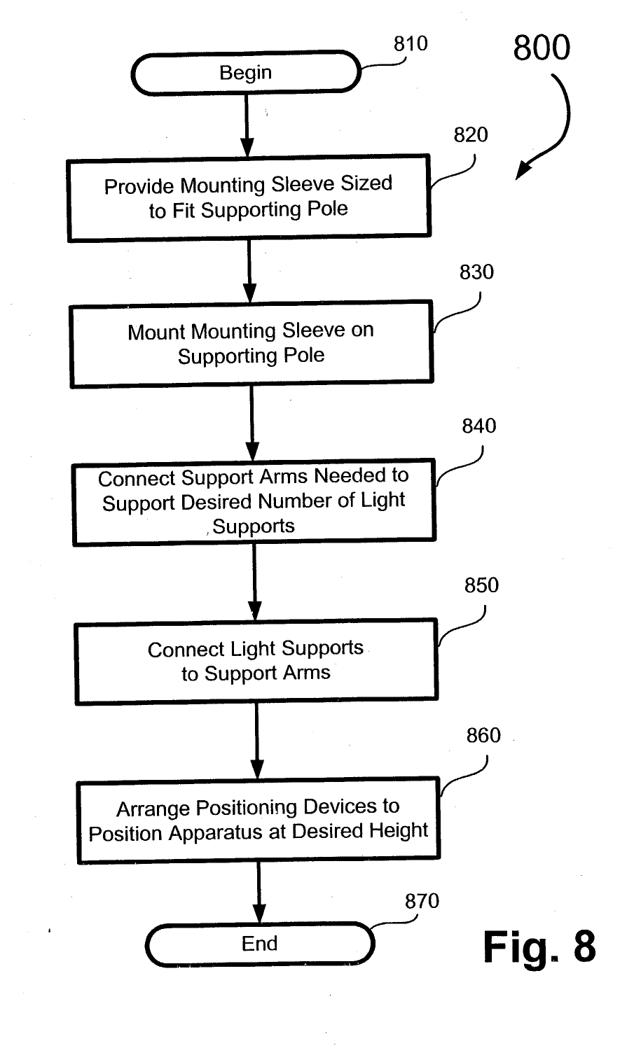

FIG. 8 shows a routine 800 according to an embodiment of the present invention. The routine 800 begins at a block 810. At a block 820, a mounting sleeve sized to fit the supporting pole is provided. At a block 830, the mounting sleeve is mounted on the supporting pole. At a block 840, a number of support arms to support the desired number of lights are connected to the mounting sleeve. At a block 850, light supports are connected with the support arms to support the desired number of lights. At a block 860, using positioning devices the apparatus is positioned at a desired height on the supporting pole. The routine 800 then concludes at a block 870.

It will be appreciated that various forms of lights could be used with embodiments of the present invention. Wax candles could be used with or without candle holders. Similarly, floating candles in holders, oil lights, and electric lights could be similarly supported. Embodiments of the present invention are not restricted in terms of the lights chosen.

In addition, while various embodiments of the present invention have been described in relation to positioning embodiments of the invention above a table surface, embodiments and uses of the invention are not so limited. Embodiments of the present invention could be used on poles of various lengths, whether the poles are mounted in the ground, or are placed in a stand on the ground or another surface.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus for supporting lights, the apparatus comprising:
a mounting sleeve configured to receive a supporting pole therein, the mounting sleeve having first inner cross-sectional dimensions sized such that the mounting sleeve is slidable along a major axis of the supporting pole and such that the mounting sleeve is generally constrained from tilting in orthogonal dimensions to the major axis of the supporting pole;
a plurality of support arms coupled to the mounting sleeve and extending outwardly from an outer surface of the mounting sleeve; and
a plurality of light supports coupled to the support arms.

2. The apparatus of claim 1, further comprising a positioning device configured to secure the mounting sleeve to the supporting pole such that slidability of the mounting sleeve along the major axis of the supporting pole in at least one direction is limited.

3. The apparatus of claim 2, wherein the positioning device includes a pole clamping device configured to frictionably engage the supporting pole such that when the pole clamping device is deployed in a clamped position the clamping device is not readily slidable along the major axis of the supporting pole.

4. The apparatus of claim 3, wherein the pole clamping device is integrated with the mounting sleeve such that the mounting sleeve is not slidable along the major axis of the supporting pole when the pole clamping device is deployed in the clamped position.

5. The apparatus of claim 3, wherein the pole clamping device is a device separate from the mounting sleeve and configured to abut an end of the mounting sleeve such that the mounting sleeve is not slidable past the clamping device along the major axis of the supporting pole when the pole clamping device is deployed in the clamped position.

6. The apparatus of claim 3, wherein the pole clamping device is deployed into the clamped position using a transverse mounting screw passing through a threaded opening in a side of the pole clamping device and engaging an outer surface of the supporting pole.

7. The apparatus of claim 3, wherein the pole clamping device is deployed into the clamped position using an adjustment screw passing through at least two sides of the pole clamping device such that tightening the adjustment screw adjusts inner clamp dimensions to frictionably engage an outer surface of the supporting pole.

8. The apparatus of claim 2, wherein the positioning device includes at least one spacing sleeve for positioning the mounting sleeve along the major axis of the supporting pole at a distance removed from a surface, the surface defining an opening through which the supporting pole extends, the spacing sleeve having second inner cross-sectional dimensions sized such that the spacing sleeve is slidable along the major axis of the supporting pole and a first outer dimension at a first spacing sleeve end transverse to the major axis of the supporting pole such that the spacing sleeve cannot pass through the opening in the surface through which the supporting pole extends and a second outer dimension at a second sleeve end transverse to the axis of the spacing sleeve such that the mounting sleeve cannot pass completely over the spacing sleeve.

9. The apparatus of claim 8, wherein a plurality of spacing sleeves are usable together to increase the distance from which the mounting sleeve is removed from the surface.

10. The apparatus of claim 2, wherein the positioning device includes a cap configured to engage a top end of the supporting pole, the cap being arranged to prevent the supporting pole from sliding completely through the mounting sleeve.

11. The apparatus of claim 1, wherein the support arms are shapeable in at least one of a straight shape, an upward-reaching shape, a downward-reaching shape, an upswept shape, a downswept shape, or a curved shape.

12. The apparatus of claim 10, wherein different support arms have different shapes.

13. The apparatus of claim 1, wherein at least two of the support arms have different lengths.

14. The apparatus of claim 1, wherein at least two of the support arms support a single light support.

15. The apparatus of claim 1, wherein one of the support arms supports at least two light supports.

16. The apparatus of claim 1, wherein at least one of the support arms or the light supports support a shaped member.

17. The apparatus of claim 1, wherein at least one of the light supports is configured to support a light holder from beneath the light holder.

18. The apparatus of claim 1, wherein at least one of the light supports includes a receiving opening and supporting arms such that a light holder can be inserted into the receiving opening and retained in position by the supporting arms.

19. An apparatus for supporting lights, the apparatus comprising:
a mounting sleeve comprising:
an inner channel configured to receive a supporting pole, the inner channel having first inner cross-sectional dimensions sized such that the mounting sleeve is slidable along a major axis of the supporting pole and is generally constrained from tilting in orthogonal dimensions to the major axis of the supporting pole; and
an outer surface disposed on the mounting sleeve on a surface opposite the inner channel; and
a plurality of support arms coupled to the mounting sleeve and extending outwardly from an outer surface of the mounting sleeve;
a plurality of light supports coupled to the support arms; and
a positioning device configured to secure the mounting sleeve to the supporting pole such that the slidability of the mounting sleeve along the major axis of the supporting pole in at least one direction is limited.

20. The apparatus of claim 19, wherein the positioning device includes a pole clamping device configured to frictionably engage the supporting pole such that when the pole clamping device is deployed in a clamped position the clamping device is not readily slidable along the major axis of the supporting pole.

21. The apparatus of claim 20, wherein the pole clamping device is deployed into the clamped position using at least one of a transverse mounting screw passing through a threaded opening in a side of the pole clamping device and engaging an outer surface of the supporting pole or an adjustment screw passing through at least two sides of the pole clamping device such that tightening the adjustment screw adjusts inner clamp dimensions to frictionably engage an outer surface of the supporting pole.

22. The apparatus of claim 19, wherein the positioning device includes at least one spacing sleeve for positioning the mounting sleeve along the major axis of the supporting pole at a distance removed from a surface, the surface defining an opening through which the supporting pole extends, the spacing sleeve having second inner cross-sectional dimensions sized such that the spacing sleeve is slidable along a major axis of the supporting pole and a first outer dimension at a first spacing sleeve end transverse to the major axis of the supporting pole such that the spacing sleeve cannot pass through the opening in the surface through which the supporting pole extends and a second outer dimension at a second sleeve end transverse to the axis of the spacing sleeve such that the mounting sleeve cannot pass completely over the spacing sleeve.

23. The apparatus of claim 22, wherein at least one additional spacing sleeve is usable to increase the distance from which the mounting sleeve is removed from the surface.

24. The apparatus of claim 19, wherein the positioning device includes a cap configured to engage a top end of the supporting pole, the cap being arranged to prevent the supporting pole from sliding completely through the mounting sleeve.

25. The apparatus of claim 19, wherein the support arms are shapeable in at least one of a straight shape, an upward-reaching shape, a downward-reaching shape, an upswept shape, a downswept shape, or a curved shape.

26. The apparatus of claim 25, wherein different support arms have different shapes.

27. The apparatus of claim 19, wherein at least two of the support arms have different lengths.

28. The apparatus of claim 19, wherein at least two of the support arms support a single light support.

29. The apparatus of claim 19, wherein one of the support arms supports at least two light supports.

30. The apparatus of claim 19, wherein at least one of the support arms or the light supports support a shaped member.

31. The apparatus of claim 19, wherein at least one of the light supports is configured to support a light holder from beneath the light holder.

32. The apparatus of claim 19, wherein at least one of the light supports includes a receiving opening and supporting arms such that a light holder can be inserted into the receiving opening and retained in position by the supporting arms.

33. A method for providing supports for lights, the method comprising:
providing a mounting sleeve having first inner cross-sectional dimensions sized such that the mounting sleeve is slidable along a major axis of the supporting pole and is generally constrained from tilting in orthogonal dimensions to the major axis of the supporting pole;
mounting the mounting sleeve on the supporting pole;
providing a plurality of support arms configured to be supported by the mounting sleeve, the support arms extending outwardly from an outer surface of the mounting sleeve; and
providing a plurality of light supports configured to be supported by the support arms.

34. The method of claim 33, further comprising securing the mounting sleeve to the supporting pole by limiting the slidability of the mounting sleeve along the major axis of the supporting pole in at least one direction.

35. The method of claim 34, wherein the slidability of the mounting sleeve is limited by mounting a clamp on the supporting pole, the clamp frictionably engaging the supporting pole and preventing the mounting sleeve from sliding past the clamp along the major axis of the supporting pole.

36. The method of claim 34, wherein the slidability of the mounting sleeve is restricted by positioning at least one spacing sleeve around the supporting pole for positioning the mounting sleeve along the major axis of the supporting pole at a distance removed from a surface, the surface defining an opening through which the supporting pole extends, the spacing sleeve having second inner cross-sectional dimensions sized such that the spacing sleeve is slidable along a major axis of the supporting pole and a first outer dimension at a first spacing sleeve end transverse to the major axis of the supporting pole such that the spacing sleeve cannot pass through the opening in the surface through which the supporting pole extends and a second outer dimension at a second sleeve end transverse to the axis of the spacing sleeve such that the mounting sleeve cannot pass completely over the spacing sleeve.

37. The method of claim 33, wherein the support arms are shapeable in at least one of a straight shape, an upward-reaching shape, a downward reaching shape, an upswept shape, a downswept shape, or a curved shape.

38. The method of claim 37, wherein different support arms have different shapes.

39. The method of claim 33, wherein at least two of the support arms have different lengths.

40. The method of claim 33, wherein at least two of the support arms support a single light support.

41. The method of claim 33, wherein one of the support arms supports at least two light supports.

42. The method of claim 33, wherein at least one of the support arms or the light supports support a shaped member.

43. The method of claim 33, wherein at least one of the light supports is configured to support a light holder from beneath.

44. The method of claim 33, wherein at least one of the light supports includes a receiving opening and supporting arms such that a light holder can be inserted into the receiving opening and retained in position by the supporting arms.
